(19) United States
(12) Patent Application Publication
(10) Pub. No.: US 2026/0034649 A1
(43) Pub. Date: Feb. 5, 2026

(54) POWER TOOL AND CONTROL METHOD

(71) Applicant: TECHTRONIC CORDLESS GP, Anderson, SC (US)

(72) Inventors: Yong Min LI, Dongguan City (CN); Li Hua XIE, Dongguan City (CN); Guo Hui XIONG, Dongguan City (CN); Ping SHAO, Dongguan City (CN); Wei SUN, Dongguan City (CN); Zi Teng HUANG, Dongguan City (CN); Chao WEN, Dongguan City (CN)

(21) Appl. No.: 19/274,283

(22) Filed: Jul. 18, 2025

(30) Foreign Application Priority Data
Jul. 30, 2024 (EP) 24191761

(51) Int. Cl. B25B 23/147; B25B 21/02

(52) U.S. Cl. CPC B25B 23/1475; B25B 21/023

(57) ABSTRACT

A power tool, comprises an activation trigger, an impact assembly comprising a hammer and an output shaft, a motor arranged to drive the hammer of the impact assembly, an impact sensor configured to sense one or more impact events of the impact assembly, and a motor controller configured to activate the motor in response to a user input via the activation trigger, determine an impacting state of the impact assembly based on the impact sensor output, in response to determining the impacting state of the impact assembly, to measure an impact progression of the impact assembly based on the impact sensor output, and deactivate the motor in response to measuring a predefined impact progression.

### FIELD OF THE DISCLOSURE

The present disclosure relates to a power tool and, in particular to an impact wrench or impact driver.

### BACKGROUND OF THE DISCLOSURE

A power tool such as an impact wrench or impact driver is configured to operate in a first mode of operation where an output shaft is rotated smoothly. When resistance is encountered, the power tool transitions to a second impacting mode of operation which delivers a series of impacts to further rotate the output shaft. This can increase the torque that can be applied to a work piece, improving the efficiency of a tightening operation.

In many such power tools, the impacts are delivered very rapidly to further improve efficiency. However, it is difficult for a user to judge the correct number of impacts for the desired tightness, and it is easy to over-tighten a work piece. In any case, difficult to consistently replicate a certain applied torque and consistently reach a recommended torque for a given work piece.

It is an object of the present disclosure to address or at least partially ameliorate some of the above problems of the current approaches.

### SUMMARY OF THE DISCLOSURE

Features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims.

In accordance with a first aspect of the present disclosure, there is provided a power tool, comprising an activation trigger, an impact assembly comprising a hammer and an output shaft, a motor arranged to drive the hammer of the impact assembly, an impact sensor configured to sense one or more impact events of the impact assembly and a motor controller configured to activate the motor in response to a user input via the activation trigger, determine an impacting state of the impact assembly based on the impact sensor output, in response to determining the impacting state of the impact assembly, to measure an impact progression of the impact assembly based on the impact sensor output, and deactivate the motor in response to measuring a predefined impact progression.

The impact sensor may include an accelerometer.

The motor controller may be configured to determine the impacting state based on a first impact spike output by the accelerometer, and measure the impact progression by counting the number of impact spikes output by the accelerometer.

The predefined impact progression may be a predefined number of impact spikes.

The power tool may include one or more magnets attached to the output shaft of the impact assembly.

The impact sensor may include one or more Hall-effect sensors arranged to sense an angular position of the one or more magnets about a rotation axis of the output shaft.

The motor controller may be configured to determine the impacting state based on a first pause in rotation of the magnets.

The motor controller may be configured to measure the impact progression by counting the number of rotation spikes output by the Hall sensors.

The predefined impact progression may be a predefined number of rotation spikes.

The motor controller may be configured to measure the impact progression by determining the change in angular position of the magnets from the beginning of the impacting state.

The predefined impact progression may be a predefined change in angular position.

Two magnets may be attached to the output shaft.

The impact sensor may include four Hall-effect sensors equally spaced around the rotation axis of the output shaft.

The output shaft may be formed having one or more flat planes with each magnet mounted attached to one of the flat planes.

The power tool may include an annular sensor board, where the impact sensor is mounted on the annular sensor board, and the output shaft is arranged to pass through an opening in the annular sensor board.

The power tool may include a handle, where the trigger is mounted on the handle and the motor controller and the accelerometer are mounted on a main control board arranged within the handle.

In accordance with a second aspect of the present disclosure, there is provided a method of controlling a power tool having an impact assembly comprising a hammer and an output shaft, comprising activating a motor of the power tool to drive the hammer of the impact assembly in response to a user input via an activation trigger; determining an impacting state of the impact assembly based on an output of an impact sensor sensing one or more impact events of the image assembly; measuring an impact progression of the impact assembly based on the impact sensor output; and deactivating the motor in response to measuring a predefined impact progression.

The method may include determining the impacting state based on a first impact spike output by an accelerometer; and measuring the impact progression by counting the number of impact spikes output by the accelerometer.

The predefined impact progression may be a predefined number of impact spikes.

The impact sensor may include one or more Hall-effect sensors arranged to sense an angular position about a rotation axis of the output shaft of a one or more magnets attached to the output shaft of the impact assembly.

Determining the impacting state may be based on a first pause in rotation of the magnets.

The method may include measuring the impact progression by counting the number of rotation spikes output by the Hall sensors.

The predefined impact progression may be a predefined number of rotation spikes.

The method may include measuring the impact progression by determining the change in angular position of the magnets from the beginning of the impacting state.

The predefined impact progression may be a predefined change in angular position.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended Figures. Understanding that these Figures depict only exemplary embodiments of the disclosure and are not therefore to be considered to be limiting of its scope, the principles herein are described and explained with additional specificity and detail through the use of the accompanying Figures.

Preferred embodiments of the present disclosure will be explained in further detail below by way of examples and with reference to the accompanying Figures, in which:

FIG. 1 is a schematic diagram of a power tool according to an embodiment.

FIG. 2 is a schematic diagram of an impact assembly of the power tool according to an embodiment.

FIG. 3 is a schematic diagram of am output shaft of the power tool according to an embodiment.

FIG. 4 is a schematic diagram of a secondary housing of the power tool according to an embodiment.

FIG. 5 is a schematic diagram of a circuit board of the power tool according to an embodiment.

FIG. 6 is a flowchart showing a method of controlling a power tool according to an embodiment.

### DETAILED DESCRIPTION OF THE PREFERRED EMBODIMENTS

Various embodiments of the disclosure are discussed in detail below. While specific implementations are discussed, it should be understood that this is done for illustration purposes only. A person skilled in the relevant art will recognize that other components and configurations may be used without departing from the scope of the disclosure.

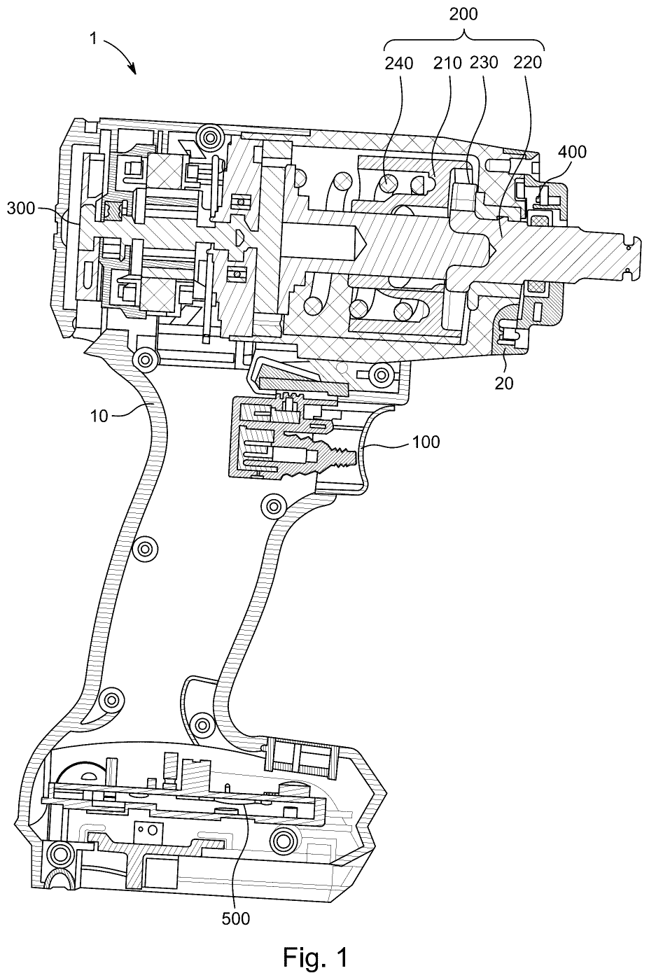

Referring to the drawings, there is shown in FIG. 1 a power tool according to an embodiment. The power tool may be an impact wrench or impact driver. The power tool comprises an activation trigger, an impact assembly, a motor, an impact sensor and a motor controller.

The motor controller is configured to activate the motor in response to a user input via the activation trigger. The activation trigger may be formed in an opening of a main housing of the power tool. The activation trigger may be configured to slide or pivot with respect to the main housing. Movement of the activation trigger e.g. by user actuation, may cause the activation trigger to press against a corresponding activation switch within the main housing. The activation switch may send a signal to the motor controller to activate the motor.

The impact assembly comprises a hammer and an output shaft. The motor is arranged to drive the hammer of the impact assembly. The motor may be configured to drive the hammer to rotate about a working axis of the power tool. In a first non-impacting mode of operation, the rotating hammer may engage with the output shaft to rotate the output shaft about the working axis of the power tool. The impact assembly may further comprise an anvil coupled to or formed with the output shaft. The hammer may engage with the anvil to rotate the output shaft.

The first mode of operation may be a low torque mode of operation. As a rotational resistance on the output shaft increases, e.g. as a work piece become tightened, a driving torque of the motor increases and the power tool may transition to a second impacting mode of operation. The engagement between the hammer and the output shaft may be limited by torque, e.g. a first camming surface of the hammer may be urged against a first camming surface of the anvil by a resilient element. The resilient element may be spring e.g. a coil spring or a flat spring.

In the second mode of operation, as the rotational resistance increases, the torque may overcome the resilient element and the camming surfaces may slide relative to one another.

The camming action may cause a relative axial movement between the hammer and anvil. The axial movement may cause the hammer to disengage from the anvil. Upon disengaging from the anvil, the hammer may be released from the rotational resistance and may rotate freely. In this way, the hammer may be accelerated by the motor. Disengagement of the camming surfaces may remove the force on the resilient element, such that the resilient element can act to restore the axial position of the hammer and urge the hammer against the anvil. By restoring the axial position of the hammer, the rotating hammer may make contact with the camming surface of the angle. The rotating hammer may impact the camming surface of the anvil.

In this way, the impact of the hammer may improve a driving force of the power tool. After impact, the rotational resistance will again cause axial movement and disengagement of the hammer, leading to a reciprocating linear movement with repeated rotational impacts. The hammer and anvil may each include one or more camming surfaces spaced equally about their circumference, such that each impact is after one full rotation or a partial rotation of the hammer.

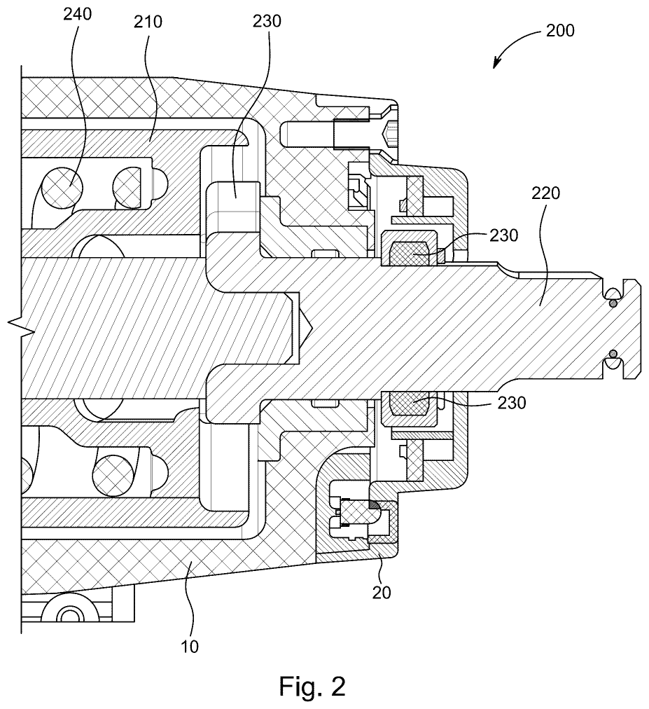

FIG. 2 is a schematic diagram of the impact assembly of the power tool according to an embodiment.

The power tool may include one or more magnets attached to the output shaft of the impact assembly. The output shaft may be formed with a first end and a second end. The first end may be arranged within the main housing of the power tool. The first end may be coupled to or formed as the anvil of the impact assembly. The output shaft may extend through an opening in the main housing, such that the second end of the output shaft is arranged outside the main housing. The second end may be formed to engage with a work piece e.g. a bolt to be tightened.

The magnets may be attached to a mid-point of the output shaft, between the first end and the second end. In some examples, the magnets may be arranged outside the main housing. The magnets may be arranged within a secondary housing e.g. beneath a cover attached to the main bousing. In some examples, the magnets may be arranged within the main housing.

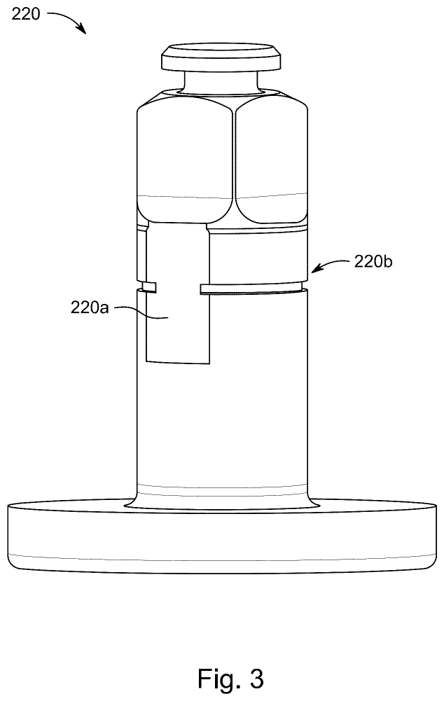

FIG. 3 is a schematic diagram of the output shaft of the power tool according to an embodiment.

One or more magnets may be attached to the output shaft. As shown, two magnets may be attached to the output shaft. In some examples a single magnet may be attached to the output shaft. The output shaft may be formed having one or more flat planes with each magnet mounted attached to one of the flat planes. In some examples, the output shaft may be formed with one or more recesses to retain the magnets.

The impact sensor is configured to sense one or more impact events of the impact assembly. Referring again to FIG. 2, the power tool may include an annular sensor board. The output shaft may be arranged to pass through an opening in the annular sensor board. The impact sensor may be mounted on the annular sensor board.

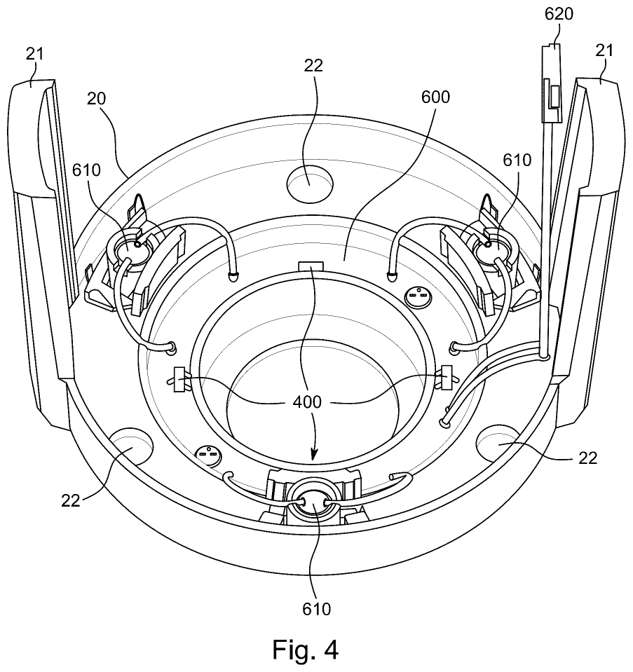

FIG. 4 is a schematic diagram of the secondary bousing of the power tool according to an embodiment. The secondary housing may be a cover configured to attach to the main bousing. The secondary housing may include a central opening for the output shaft to pass through. One or more lighting elements may be arranged around the central opening. The lighting element may be outwardly facing to illuminate the second end of the output shaft and the work piece. The lighting elements may be LEDs. The secondary housing may include one or more positioning members. The positioning members may be formed as projections configured with corresponding grooves on the main housing, such that the secondary housing can be attached with the correct position and alignment. The secondary housing may include one or more fixing points. For example, the secondary housing may include one or more holes for a fixing element, e.g. a screw, to pass through and attach to the main housing. Alternatively, the secondary housing may be provided with one or more clips or other fixing means.

The angular sensor board may be mounted within the secondary housing. The annular sensor board may be arranged around the central opening of the secondary housing. The lighting elements may be mounted on or otherwise connected to the annular circuit board. The annular circuit board may include a power connector arranged to extend into the main housing and connected with a power supply, e.g battery, of the power tool.

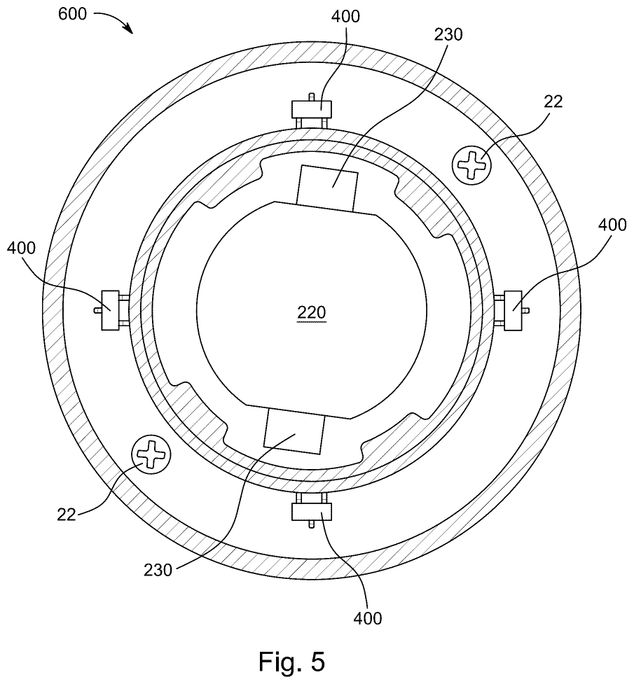

FIG. 5 is a schematic diagram of the circuit board of the power tool according to an embodiment.

The impact sensor may include one or more Hall-effect sensors arranged to sense an angular position of the one or more magnets about a rotation axis of the output shaft. The Hall-effect sensors may be mounted on or otherwise connected to the annular circuit board. In some examples, the impact sensor may include four Hall-effect sensors equally spaced around the rotation axis of the output shaft. Other examples, may include any suitable number of sensors.

Each of the Hall-effect sensors may be configured to output a signal proportional to the sensed magnetic field. The magnetic field emitted by each of the one or more magnets may be proportional to the inverse square of the distance from the magnet. In this way, the impact sensor can determine the position of the magnets based on the fields sensed by the one or more Hall-effect sensors. The impact sensor may include a controller to calculate the magnet positions based on the value of a field sensed by each of the Hall-effect sensors, or determine the positions by comparison to a look up table with pre-calibrated values.

The motor controller is configured to determine an impacting state of the impact assembly based on the impact sensor output. The motor controller may be configured to determine the impacting state based on a first pause in rotation of the magnets. A pause in rotation may indicate that the rotational resistance on the output shaft has increased to the point where the motor torque is not sufficient to rotate the output shaft. At this point the power tool may transition to the second mode of operation. In the second mode of operation the power tool may be considered to be in an impacting state, due to the reciprocating linear movement of the hammer with repeated rotational impacts.

The motor controller is configured to measure an impact progression of the impact assembly based on the impact sensor output, in response to determining the impacting state of the impact assembly. The motor controller may be configured to measure the impact progression by counting the number of rotation spikes output by the Hall sensors. In the second impacting mode of operation, the output shaft may be generally stationary until the rotating hammer impacts the camming surface of the anvil. The impact of the hammer may cause the output shaft to rotate by a certain amount, leading to a rotation spike detected by the Hall sensors. The motor controller may be configured to count the number of rotation spikes, indicating the number of impacts between the hammer and the anvil.

The motor controller is configured to deactivate the motor in response to measuring a predefined impact progression. The predefined impact progression may be a predefined number of rotation spikes. The predefined number of rotation spikes may be 10. Alternatively, the predefined number of rotation spikes may be between 5 and 20. The predefined number of rotation spikes may be more or less than this range according to the requirements of the task and the tool e.g. the resistance offered by the work piece and the impacting power of the tool.

In this way, the power tool may be controlled in a way which causes the power tool to rotate the work piece smoothly in the first mode of operation and, upon encountering increased resistance and transitioning to the second impacting state, impact the work piece a predefined number of times before deactivating. In this way, the power tool can provide an automated work operation e.g. a tightening operation. The tightening operation can tighten the work piece, e.g. a bolt, smoothly, and then impact the bolt a predefined number of times. In this way, the work operation can be straightforward for the user to carry out without requiring skill or judgement. Each work operation can be predictable and repeatable. For example, the predefined number of impacts may correspond to a recommended torque value or torque range for tightening a particular work piece.

The motor controller may be configured to measure the impact progression by determining the change in angular position of the magnets from the beginning of the impacting state. The predefined impact progression may be a predefined change in angular position. The predefined change in angular position may be between 30 and 90 degrees. The predefined change in angular position may be more or less than this range according to the requirements of the task and the tool e.g. the resistance offered by the work piece and the impacting power of the tool.

The impact sensor may include an accelerometer and/or gyroscope. The accelerometer may be configured to measure linear acceleration along each of three orthogonal axes. The gyroscope may be configured to measure angular acceleration around each of three orthogonal axes. The accelerometer and gyroscope may be combined into a single 6-axis acceleration sensor. Each impact by the hammer against the anvil may result to a sudden movement of the power tool. The sudden movement caused by the output may result in an acceleration spike detectable by the impact sensor.

The motor controller may be configured to determine the impacting state based on a first impact spike output by the accelerometer. The motor controller may be configured to measure the impact progression by counting the number of impact spikes output by the accelerometer. The predefined impact progression may be a predefined number of impact spikes, substantially as described above with respect to the rotation spikes.

The power tool may include a handle, where the trigger is mounted on the handle and the motor controller and the accelerometer are mounted on a main control board arranged within the handle. In this way, the impact sensor may be mounted with the motor controller, without requiring an additional circuit board close to the output shaft.

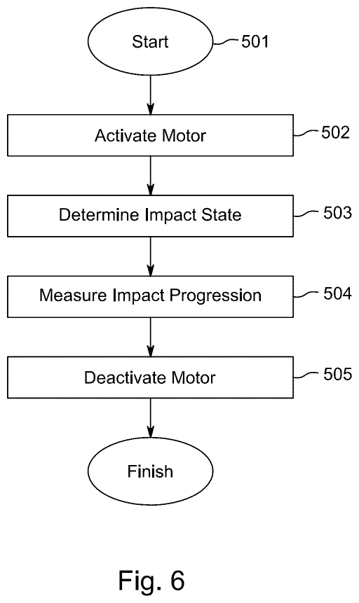

FIG. 6 is a flowchart showing a method of controlling a power tool having an impact assembly comprising a hammer and an output shaft according to an embodiment. The method starts at step S01.

At step S02, the motor is activated to drive the hammer of the impact assembly, in response to a user input via an activation trigger.

At step S03, an impacting state of the impact assembly is determined based on an output of an impact sensor sensing one or more impact events of the image assembly.

At step S04, an impact progression of the impact assembly is measured based on the impact sensor output.

At step S05, the motor is deactivated in response to measuring a predefined impact progression.

The method finishes at step S06.

The above embodiments are described by way of example only. Many variations are possible without departing from the scope of the disclosure as defined in the appended claims.

For clarity of explanation, in some instances the present technology may be presented as including individual functional blocks including functional blocks comprising devices, device components, steps or routines in a method embodied in software, or combinations of hardware and software.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, Universal Serial Bus (USB) devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. A power tool, comprising:
an activation trigger;
an impact assembly comprising a hammer and an output shaft;
a motor arranged to drive the hammer of the impact assembly;
an impact sensor configured to sense one or more impact events of the impact assembly; and
a motor controller configured to:
activate the motor in response to a user input via the activation trigger,
determine an impacting state of the impact assembly based on the impact sensor output,
in response to determining the impacting state of the impact assembly, to measure an impact progression of the impact assembly based on the impact sensor output; and
deactivate the motor in response to measuring a predefined impact progression.

2. The power tool of claim 1, wherein the impact sensor comprises an accelerometer, and the motor controller is configured to:
determine the impacting state based on a first impact spike output by the accelerometer; and
measure the impact progression by counting a number of impact spikes output by the accelerometer; and
wherein the predefined impact progression is a predefined number of impact spikes.

3. The power tool of claim 2, further comprising a handle;
wherein the trigger is mounted on the handle; and
wherein the motor controller and the accelerometer are mounted on a main control board arranged within the handle.

4. The power tool of claim 1, further comprising one or more magnets attached to the output shaft of the impact assembly;
wherein the impact sensor comprises one or more Hall-effect sensors arranged to sense an angular position of the one or more magnets about a rotation axis of the output shaft; and
wherein the motor controller is configured to determine the impacting state based on a first pause in rotation of the magnets.

5. The power tool of claim 4, wherein the motor controller is configured to measure the impact progression by counting a number of rotation spikes output by the Hall-effect sensors; and
wherein the predefined impact progression is a predefined number of rotation spikes.

6. The power tool of claim 4, wherein the motor controller is configured to measure the impact progression by determining a change in angular position of the magnets from a beginning of the impacting state; and
wherein the predefined impact progression is a predefined change in angular position.

7. The power tool of claim 4, wherein two magnets are attached to the output shaft; and
wherein the impact sensor comprises four Hall-effect sensors equally spaced around the rotation axis of the output shaft.

8. The power tool of claim 4, wherein the output shaft is formed having one or more flat planes with each magnet mounted attached to one of the flat planes.

9. The power tool of claim 1, further comprising an annular sensor board; wherein the impact sensor is mounted on the annular sensor board; and
wherein the output shaft is arranged to pass through an opening in the annular sensor board.

10. A method of controlling a power tool having an impact assembly comprising a hammer and an output shaft, comprising:
activating a motor of the power tool to drive the hammer of the impact assembly in response to a user input via an activation trigger;
determining an impacting state of the impact assembly based on an output of an impact sensor sensing one or more impact events of an image assembly;
measuring an impact progression of the impact assembly based on the impact sensor output; and
deactivating the motor in response to measuring a predefined impact progression.

11. The method of claim 10, further comprising:
determining the impacting state based on a first impact spike output by an accelerometer; and
measuring the impact progression by counting a number of impact spikes output by the accelerometer;
wherein the predefined impact progression is a predefined number of impact spikes.

12. The method of claim 10, wherein the impact sensor comprises one or more Hall-effect sensors arranged to sense an angular position about a rotation axis of the output shaft of a one or more magnets attached to the output shaft of the impact assembly; and
wherein determining the impacting state is based on a first pause in rotation of the magnets.

13. The method of claim 12, further comprising:
measuring the impact progression by counting a number of rotation spikes output by the Hall-effect sensors;
wherein the predefined impact progression is a predefined number of rotation spikes.

14. The method of claim 12, further comprising:
measuring the impact progression by determining a change in angular position of the magnets from a beginning of the impacting state;
wherein the predefined impact progression is a predefined change in angular position.
